(19) United States
(12) Patent Application Publication
(10) Pub. No.: US 2025/0336023 A1
(43) Pub. Date: Oct. 30, 2025

(54) GRAPHICS PROCESSING

(71) Applicant: Arm Limited, Cambridge (GB)

(72) Inventors: Ozgur Tasdizen, Cambridge (GB); Ian Victor Devereux, Sawston (GB); Daren Croxford, Swaffham Prior (GB); Andreas Due Engh-Halstvedt, Trondheim (NO)

(73) Assignee: Arm Limited, Cambridge (GB)

(21) Appl. No.: 18/649,080

(22) Filed: Apr. 29, 2024

(51) Int. Cl. G06T 1/20; G06F 15/80

(52) U.S. Cl. CPC G06T 1/20; G06F 15/80

(57) ABSTRACT

One or more tasks for a processing job are distributed to processing cores of a plurality of processing cores for processing. A first set of one or more of the processing cores is configured to have a higher priority for the processing of tasks of a first type compared to a second set of one or more others of the processing cores. Tasks are distributed to the first and second sets of one or more processing cores for processing in accordance with the priorities of those sets of one or more processing cores for the processing of tasks of the first type.

### BACKGROUND

The technology described herein relates to graphics processing, and in particular to the operation of graphics processing pipelines that include one or more programmable processing stages (“shaders”).

Many graphics processors execute, inter alia, programmable processing stages, commonly referred to as “shaders”, of a graphics processing pipeline that the graphics processor implements. For example, a graphics processing pipeline may include one or more of, and typically all of: a geometry shader, a vertex shader and a fragment (pixel) shader. These shaders are programmable processing stages that execute shader programs on input data values to generate a desired set of output data, such as appropriately shaded and rendered fragment data in the case of a fragment shader, for processing by the rest of the graphics processing pipeline and/or for output.

It is also known to use graphics processors and graphics processing pipelines, and in particular the shader operation of a graphics processor and graphics processing pipeline, to perform more general computing operations, e.g. in the case where a similar operation needs to be performed in respect of a large volume of plural different input data values. These operations are commonly referred to as “compute shading” operations and a number of specific compute APIs, such as OpenCL and Vulcan, have been developed for use when it is desired to use a graphics processor and a graphics processing pipeline to perform more general computing operations. Compute shading is used for computing arbitrary information. It can be used to process graphics-related data, or for tasks not directly related to performing graphics processing.

A graphics processing pipeline shader thus performs processing by running small programs for each “work item” in an output to be generated, such as a render target, e.g. frame (a “work item” in this case would be usually a vertex or a sampling position (e.g. in the case of a fragment shader)). Where the graphics processing pipeline is being used for “compute shading” (e.g. under OpenCL or DirectCompute) then the work items will be appropriate compute shading work items. This shader operation generally enables a high degree of parallelism, in that a typical render output, e.g. frame, features a rather large number of work items (e.g. vertices or fragments), each of which can be processed independently.

Many graphics processors include a plurality of processing cores (commonly referred to as “shader cores”) that perform, inter alia, shader operations by executing processing jobs.

To perform a shader operation, one or more processing jobs are generated and sent to the processing cores for processing, for example by inclusion in a command stream of the graphics processor. For example, when performing compute shading, one or more compute jobs may be included in a command stream and sent to the processing cores for processing.

To allow processing jobs to be parallelised across multiple processing cores, the processing jobs are divided into one or more “tasks”, and these tasks distributed across, and processed by, respective processing cores. A task may perform a subset of the processing for a processing job.

In many graphics processors, the processing cores are capable of, and used for, executing diverse workloads. For example, the same set of processing cores may perform different shader operations, such as one or more of, and typically all of: compute shading, machine learning shading, geometry shading, vertex shading, and fragment (pixel) shading.

In such graphics processors, there may be situations where multiple types of processing tasks, for example tasks for different processing jobs, are to be distributed for processing by the processing cores (at the same time).

For example, more than one different processing job may be received for processing by the graphics processor. In this case respective tasks for (each of) the processing jobs must be distributed for processing by respective processing cores.

The Applicants believe that there remains scope for improvements to allocation of tasks for processing in graphics processors comprising plural processing (shader) cores.

### BRIEF DESCRIPTION OF THE DRAWINGS

Embodiments of the technology described herein will now be described by way of example only and with reference to the accompanying drawings, in which:

FIG. 1 shows an exemplary graphics processing system in which the technology described herein may be implemented;

FIG. 2 shows schematically a graphics processor that may be operated in the manner of the technology described herein;

FIG. 3 shows a flow chart describing the processing of processing jobs using a graphics processor in accordance with the technology described herein;

FIG. 4 shows schematically a graphics processor distributing processing tasks for two different workloads in accordance with an embodiment;

FIG. 5 shows schematically how the priority of shader cores (processing cores) for processing compute tasks may be set in accordance with an embodiment;

FIG. 6a and FIG. 6b show schematically the processing of three processing jobs on a plurality of shader cores (processing cores) in accordance with an example and an embodiment;

FIGS. 7a to 7c show schematically the distribution of processing tasks for a processing job to a plurality of shader cores (processing cores) in accordance with embodiments of the technology described herein;

FIGS. 8a to 8c show schematically the distribution of processing tasks for a processing job to a plurality of shader cores (processing cores) in accordance with embodiments of the technology described herein;

FIG. 9 shows schematically the division of a processing job into tasks in accordance with an embodiment of the technology described herein;

FIG. 10 shows schematically the division of the same processing job as FIG. 9 into tasks in accordance with another embodiment of the technology described herein;

Like reference numerals are used for like features in the Figures, where appropriate.

### DETAILED DESCRIPTION

A first embodiment of the technology described herein comprises a method of operating a graphics processor, the graphics processor comprising a plurality of processing cores, the processing cores operable to execute processing tasks for processing jobs, the method comprising:
receiving one or more processing jobs for processing by the graphics processor;
distributing one or more task for the processing job or jobs to processing cores of the plurality of processing cores for processing; and
processing the tasks with the respective processing cores;
wherein a first set of one or more of the processing cores of the graphics processor is configured to have a higher priority for the processing of tasks of a first type compared to a second set of one or more others of the processing cores; the method comprising:
distributing the tasks to the first and second sets of one or more processing cores for processing in accordance with the priorities of those sets of one or more processing cores for the processing of tasks of the first type.

A second embodiment of the technology described herein comprises a graphics processor comprising:
a plurality of processing cores, the processing cores operable to execute processing tasks for processing jobs;
a task distribution circuit configured to distribute tasks for processing jobs to processing cores of the plurality of processing cores for processing; and
a processing circuit or circuits operable to configure a first set of one or more of the processing cores of the graphics processor to have a higher priority for the processing of tasks of a first type compared to a second set of one or more others of the processing cores;
wherein the task distribution circuit is configured to:
distribute tasks to the first and second sets of one or more processing cores for processing in accordance with the priorities of those sets of one or more processing cores for the processing of tasks of the first type.

The technology described herein broadly relates to the processing of processing tasks for processing jobs, by a graphics processor comprising a plurality of processing cores. In particular, the technology described herein relates to the distribution of tasks for one or more processing jobs to processing cores of the plurality of processing cores for processing.

In the technology described herein, a first set of one or more of the processing cores of the graphics processor is configured to have a higher priority for the processing of tasks of a first type compared to a second set of one or more others of the processing cores. Tasks are distributed to the first and second sets of one or more processing cores for processing in accordance with the priorities of those sets of one or more processing cores for the processing of tasks of the first type.

The Applicants have recognised in this regard that certain processing jobs may be (more) latency critical, e.g. where the issuance of further processing jobs depends directly on the completion of a processing job.

The Applicants have further recognised that simply prioritising such latency-critical tasks across all the available processing cores, such that the latency critical tasks will be processed by all the processing cores before any “non-latency critical” processing tasks may lead to under-utilisation of the processing cores.

By prioritising a first type of task (e.g. more latency critical tasks) on a first set of one or more processing cores compared to a second set of one or more (other) processing cores, the technology described herein allows for the tasks of the first type to be progressed on the first set of one or more processing cores, whilst keeping the second set of one or more processing cores available to process (other) processing tasks, for example processing tasks of a different type, such as processing tasks for different (types of) processing job(s).

As will be discussed further below, this may allow for increased utilisation of processing cores, and may allow (overall) latency in the system to be reduced.

In the technology described herein, the graphics processor comprises a plurality of processing cores. The plurality of processing cores may comprise any suitable number of processing cores, such as 2, 4, 8, 16 or 32 processing cores. Other numbers of processing cores are, of course, possible as desired.

In the technology described herein, a first set of one or more of the processing cores of the graphics processor is configured to have a higher priority for the processing of tasks of a first type compared to a second set of one or more (other) of the processing cores.

Correspondingly, when distributing tasks to the first and second sets of one or more processing cores, tasks are distributed in accordance with the priorities of those sets of one or more processing cores for the processing of tasks of the first type.

In some embodiments, when tasks of the first type are being distributed to processing cores, then the tasks of the first type are (only) distributed amongst processing cores having the higher priority for tasks of the first type.

In an embodiment, when a plurality of tasks are distributed to the first and second set of processing cores, the plurality of tasks comprising one or more tasks of the first type, and one or more processing tasks of another type, the processing tasks of the first type are distributed to the first set of processing cores, whilst the other processing tasks are distributed to the second set of processing cores.

However, when the tasks to be distributed to the first and second set of processing cores comprises only tasks of the first type, then in an embodiment the tasks of the first type are distributed to both the first and the second set of processing cores.

The processing jobs may be generated and provided to the processor in any suitable and desired way, such as in the usual way for the graphics processing system.

For example, and in an embodiment, the processing jobs may be provided as a command stream. In an embodiment, the processing jobs that particular types of task are for are provided as different command streams. For example, compute jobs may be provided as a command stream for compute work, whilst the non-compute jobs may be provided as a command stream for non-compute work.

A processing job can be sub-divided into tasks in any suitable and desired way, such as in the usual way for the graphics processor.

In an embodiment, the graphics processor comprises one or more iterators for dividing the processing jobs into tasks. In an embodiment, the graphics processor comprises more than one iterator, where a (and each) iterator provides different types of processing tasks to the processing cores. For example, and in an embodiment, different iterators may receive respective different types of processing jobs that are generated, and divide these different processing jobs into respective processing tasks of different types.

In some embodiments, the one or more iterators also distribute tasks to the processing cores. However, this need not be the case, and in other embodiments the graphics processor may comprise a scheduler that distributes tasks to the processing cores. Other arrangements are, of course, possible as desired.

The tasks of the first type in the technology described herein can be any suitable and desired tasks (that can be identified as tasks of the first type).

In some embodiments, tasks of the first type are tasks that are indicated as such, for example by having an associated indicator, for example a flag, that identifies the task as being a task of the first type. Alternatively, tasks of the first type may have an identifiable property, such as the nature and/or size of task, a priority setting for the task, etc., which may allow tasks of the first type to be distinguished from other tasks to be distributed to the processing cores without the need for including a specific identifier.

In one embodiment, tasks of the first type are tasks that relate to a particular type of processing, such as compute tasks (or non-compute tasks).

In some embodiments, the tasks of the first type may be associated with a particular source, different to the source of other tasks for distribution to the processing cores of the graphics processor. For example, and in an embodiment, tasks of the first type may be received from a first source of processing tasks, different to other tasks that are received for processing by the processing cores. This may be because the tasks of the first type are for processing jobs received as part of a different command stream to other processing jobs.

For example, where different processing jobs are divided into respective tasks by different respective iterators (e.g. for different command streams), the tasks of the first type may be identified on the basis of which iterator produced the task.

In embodiments, the second set of processing cores may be (and is) configured to have a higher priority for the processing of tasks of a (different) second type compared to the first set of one or more of the processing cores.

Accordingly, in an embodiment, the first set of processing cores is configured to have a higher priority for tasks of a first type compared to tasks of a second type, and the second set of processing cores is configured to have a higher priority for tasks of the second type compared to tasks of the first type.

Correspondingly, in embodiments, when distributing tasks to the first and second sets of processing cores, tasks are distributed in accordance with the priorities of those sets of processing cores for the processing of tasks of the first type and of the second type.

In an embodiment, when distributing tasks of the first type and tasks of the second type to the first and second sets of processing cores, tasks of the first type are distributed to (in an embodiment only) the first set of processing cores, and tasks of the second type are distributed to (in an embodiment only) the second set of processing cores.

However, when distributing only one of tasks of the first type of task and tasks of the second type, the tasks of the first type or tasks of the second type are in an embodiment distributed to both the first set of processing cores and the second set of processing cores.

The Applicants believe that prioritising different ones of first and second types of processing tasks in this way may be novel and inventive in its own right.

Thus, an embodiment of the technology described herein comprises a method of operating a graphics processor, the graphics processor comprising a plurality of processing cores, the processing cores operable to execute processing tasks for processing jobs, the method comprising:
receiving one or more processing jobs for processing by the graphics processor;
distributing one or more tasks for the processing job or jobs to processing cores of the plurality of processing cores for processing; and
processing the tasks with the respective processing cores;
wherein a first set of one or more of the processing cores of the graphics processor is configured to have a higher priority for the processing of tasks of a first type compared to tasks of a second type, and a second set of one or more others of the processing cores is configured to have a higher priority for the processing of tasks of the second type compared to tasks of the first type;
the method comprising:
distributing tasks to the first and second sets of one or more processing cores for processing in accordance with the priorities of those sets of one or more processing cores for the processing of tasks of the first type and for the processing of tasks of the second type.

Another embodiment of the technology described herein comprises a graphics processor comprising:
a plurality of processing cores, the processing cores operable to execute processing tasks for processing jobs;
a task distribution circuit configured to distribute one or more tasks for the processing job or jobs to processing cores of the plurality of processing cores for processing; and
a processing circuit or circuits operable to configure a first set of one or more of the processing cores of the graphics processor to have a higher priority for the processing of tasks of a first type compared to tasks of a second type, and a second set of one or more others of the processing cores to have a higher priority for the processing of tasks of the second type compared to tasks of the first type;
wherein the task distribution circuit is configured to:
distribute tasks to the first and second sets of one or more processing cores for processing in accordance with the priorities of those sets of one or more processing cores for the processing of tasks of the first type and for the processing of tasks of the second type.

As will be appreciated by those skilled in the art, these embodiments of the technology described herein may, and in an embodiment do, comprise any one or more or all of the features of the embodiments of the technology described herein, as appropriate.

Prioritisation of tasks of a first type and a second type on different sets of processing cores in this manner may allow for increased utilisation of processing cores, for example when not all of the processing cores can be simultaneously used for the processing of tasks of the first type or the second type, thereby increasing throughput of processing tasks and reducing latency.

The tasks of the first type (and in embodiments the second type of task) may be any suitable and desired type of task that can be processed by the processing cores.

In an embodiment, the tasks of the first type are the tasks for processing jobs of a first type. In an embodiment, the tasks of the second type are the tasks for processing jobs of a second type. The processing jobs of the first type and the processing jobs of the second type may be any suitable and desired processing jobs.

In some embodiments, the processing jobs of the first type and the processing jobs of the second type are associated with different types of shader operations.

In an embodiment, the tasks of the first type (and/or the tasks of the second type) are compute tasks. The compute tasks are for one or more compute jobs for performing compute shading. Such compute tasks are for operations for computing arbitrary information, and may be for processing graphics-related data or for operations not directly related to performing graphics processing.

In some embodiments, the compute job is for a so-called “pilot” shader, as previously proposed by the application in their earlier UK patent application no. GB-A-2516358, which calculates constant values that may be required multiple times during processing for work items (for example during vertex shading), such that the constant value(s) calculated by the pilot shader can be calculated once, rather than each time it is (or they are) required during the vertex shading operation.

Such pilot shaders are latency critical, as they should be performed before the corresponding shading is performed, and may only require a small amount of processing resource, such as only requiring a single processing task to be executed.

In an embodiment, the tasks of the first type (and/or the second type) are non-compute tasks. The non-compute tasks are for shader operations that generate a desired set of output data for processing by the rest of the graphics processing pipeline and/or for output.

For example, and in embodiment, the tasks of the first type (and/or the second task) may be geometry tasks for geometry jobs. Such geometry tasks may be processed for a vertex shading operation. For example, the geometry tasks may be processed for a position shading operation. In some embodiments, a (and each) geometry job may comprise a vertex shading operation, e.g. position shading, for a respective draw call.

However, in other embodiments, the non-compute tasks may be for processing jobs for a different graphics processing shader operation, such as geometry shading or fragment shading.

In some embodiments, the tasks of the first type are compute tasks. In some such embodiments, the tasks of the second type are non-compute tasks.

In other embodiments, the tasks of the first type are non-compute tasks, and the tasks of the second type are compute tasks.

However, in some embodiments the tasks of the first type and the tasks of the second type may both be compute tasks, or may both be non-compute tasks, with each type of task respectively being tasks for different compute jobs or different non-compute jobs (for different compute/non-compute shader operations).

In an embodiment, the tasks of the first type are more latency critical than the tasks of the second type (or vice-versa).

For example, and in an embodiment, the tasks of the first type may be compute tasks for a (more) latency-critical compute shader operation, such as for a pilot shader. The tasks of the second type may be compute tasks for a less latency-critical compute shader.

In another embodiment, the tasks of the first type may be compute tasks for a shader operation for a physics engine for a scene, which may generate a smaller number of (more) latency critical tasks compared to other compute tasks for other compute shader operations.

In yet another embodiment, the tasks of the first type may be tasks for a (more) safety-critical operation. For example, in a graphics processor for an automotive application, processing tasks relating to a dash board may be deemed more safety-critical than processing tasks relating to an entertainment system.

It would be possible for the priority of a (and each) processing core (and so whether a processing core is comprised in the first or second set of processing cores) to be fixed, such that the processing core will (always) have a higher priority for processing tasks of the first type (i.e. will always be comprised in the first set of processing cores), or will not have a higher priority for the processing of the tasks of the first type (and so will (always) be comprised in the second set of processing cores), and in an embodiment that is what is done.

For example, the first and second set of processing cores may be particular, pre-determined sets of the plurality of processing cores.

However, in an embodiment, the priority of a (and each) processing core may be set dynamically (i.e. can be set and varied in use).

In some such embodiments, a processing core may be (and is) associated with a configurable priority setting, such as a “priority” control bit, which can be set (in use) to set whether the processing core has the higher priority for processing of tasks of the first type.

When distributing tasks to the processing cores, the priority setting can then be used to determine whether a particular processing core has the higher priority for tasks of the first type, or not, such that the tasks can be distributed appropriately.

The priority of the second set of processing cores for the second type of task (where present) may correspondingly be controlled and determined in any suitable and desired way. In an embodiment, the priority of the second set of processing cores for the second type of task is controlled in the same way as described above with respect to the first set of processing cores with respect to the first type of task.

In an embodiment, the same priority setting is used to determine whether a processing core has a higher priority for tasks of the first type or a higher priority for tasks of the second type, such that a priority setting indicates whether one or more associated processing cores have a priority for tasks of the first type or for tasks of the second type.

In an embodiment, the priority of a and each processing core may be set individually. For example, and in embodiments, there may be a one-to-one correspondence between priority control bits and processing cores, such that one priority control bit sets and indicates the priority of one (and only one) processing core.

However, it will be appreciated that this need not be the case, and the priority of more than one processor may be controlled together (such that those processing cores are effectively “grouped” for priority purposes, such that they always share the same priority). For example, a (and each) priority control bit may set and indicate the priority of more than one processing core, such as two, three, four, or more processing cores as desired.

It will be appreciated that in some circumstances some of the processing cores may be inactive (for example due to constraints elsewhere in the processing pipeline, such as limited bandwidth, or due to processing cores being powered down or disabled, for example to reduce power consumption and/or heat generation), and so are not available to process tasks. Allowing the priority of processing cores to be dynamically controlled may allow the prioritising of certain tasks of the technology described herein to be implemented even when not all of the processing cores are active (i.e. available to process tasks).

The number of processing cores in the first set of processing cores and in the second set of processing cores (and so the number of processing cores that prioritise processing of tasks of the first and/or the second type) may be any suitable and desired number of processing cores.

In some embodiments, the first and the second set of processing cores comprise the same number of processing cores.

In other embodiments, the first and the second sets of processing cores may comprise different numbers of processing cores. For example, one of the first and second set of processing cores may comprise a smaller number of processing cores, such as one or two processing cores, whilst the other of the first and second set of processing cores may comprise a larger number of the processing cores, such as all of the remaining (active) processing cores.

In this way, a small number of cores may be reserved for prioritising the first type of task, for example for prioritising compute tasks, e.g. for a pilot shader, whilst the remaining processing cores may process (and in an embodiment prioritise processing) other (e.g. non-compute) tasks, such as geometry tasks for a geometry processing job of a vertex shading operation.

For example, a geometry job may generate a larger number of tasks (e.g. of the second type), and therefore may require a larger number of processing cores to complete efficiently. Processing of these tasks may also require a larger bandwidth, and therefore it may not be possible to utilise all of the processing cores for this work. However, a compute job may generate a smaller number of compute tasks (e.g. of the first type).

In such a case, having a higher priority for the compute tasks on a smaller first set of the the processing cores, such as one or two processing cores, than a (larger) second set of processing cores allows the compute tasks to be efficiently processed on the (smaller) first set of processing cores, whilst the remaining cores may process (and in an embodiment prioritise processing), the larger number of geometry tasks.

In this way, highly latency-critical compute jobs can be performed without delay on the cores that prioritise the compute tasks, with relatively little (or in many cases no) reduction in the ability to process the geometry tasks. This may lead to more efficient utilisation of the cores and increased throughput of tasks, whilst reducing the time before latency-critical tasks are processed.

Similarly, where the tasks of the first type and tasks of the second type are both compute tasks, or are both non-compute tasks, but the tasks of the first type are more latency critical, it may be beneficial to prioritise the (more latency critical) first type of tasks on a majority of the processing cores.

Of course, other distributions of the first and second sets of processing cores are possible as desired.

Whether a processing cores is in the first or second set of processing cores may be chosen and set in any suitable and desired way.

In some embodiments, a host processor of the graphics processing system including the graphics processor, for example a CPU running a driver for the graphics processor, may directly indicate which (enabled) processing cores are to be included in one or both sets of processing cores, or may indicate a particular number of processing cores to be included in one or both sets of processing cores, and the priority control settings for these processing cores may be set accordingly.

However, in other embodiments, the host processor may indicate a ratio of the number of processing cores in the first and second sets. A processing unit, such as a microcontroller (MCU) within the graphics processor, or a graphics processing unit manager, may then calculate the number of processing cores that will be included in each set of processing cores. In embodiments, the processing unit may then set the priority for one or more (and in an embodiment each) processing core, such as by modifying the priority control settings, for example writing to a control bit or flag, for the processing cores.

Using such a processing unit to calculate the actual number of processing cores to be included in each set of processing cores may allow the host processor (or a driver running thereon) to act without requiring specific details of the operation of the processing cores (such as knowledge of how many processing cores are present and/or active), thereby simplifying operations for the host processor.

In some embodiments, the host processor may also set a minimum number of processing cores to be included in the first and/or second sets of processing cores. The processing unit of the graphics processor may then allocate at least the minimum number of processing cores to the first and/or second sets of processing cores. Remaining (active) processing cores may then be assigned to the first and second sets as desired, for example and in embodiments in accordance to a ratio as described above.

In the technology described herein, one or more tasks for a (and each) processing job are distributed to processing cores of the plurality of processing cores for processing.

The division of processing jobs into tasks to be processed for the processing job may be performed in any suitable and desired way, such as in the usual way for the graphics processor.

The number of tasks that a (and each) processing job is divided into may be any suitable and desired number of processing jobs.

In some embodiments, a (and each) processing job is divided such that tasks are of a particular, in an embodiment predetermined, size.

In some other embodiments, the number of tasks for a processing job is chosen based on the number of processing cores.

In some embodiments, the number of tasks that a processing job is divided into is a multiple of the number of processing cores. For example, for a graphics processor comprising 16 processing cores, processing jobs may be divided into a number of tasks that is a multiple of 16. In this way, the processing jobs may utilise all of the available cores.

In some embodiments, the number of tasks that a processing job is divided into is altered based on the number of active processing cores. In some embodiments, the number of tasks that a processing job is divided into is a multiple of the number of active processing cores. For example, for a graphics processor comprising 16 processing cores, processing jobs may be divided into a number of tasks that is a multiple of 16 when all of the processing cores are active (e.g. powered up, enabled, and able to accept tasks), and when for example, fewer than 16 processing cores are active, for example when 12 processing cores are active, then the number of tasks that a processing job is divided into may instead be a multiple of 12.

The number of tasks for a processing job may be altered in any suitable and desired way. For example, and in an embodiment, the number of tasks for a processing job is altered by changing the size of the tasks.

In some embodiments, the number of tasks of the first type that a processing job is divided into may be chosen such that the number of tasks of the first type is a multiple of the number of processing cores in the first set of processing cores.

Similarly, the number of tasks of the second type that a (different) processing job is divided into may be chosen such that the number of tasks of the second type is a multiple of the number of processing cores in the second set of processing cores.

In this way, the tasks of the first type (and in embodiments tasks of the second type) may be distributed such that all of the processing cores with the higher priority for the tasks of the first type receive the same number of tasks, which may allow for increased utilisation of the processing cores.

Subject to the constraints of the technology described herein, the distribution of tasks to processing cores for processing may be performed in any suitable and desired way.

For example, and in an embodiment, tasks may be distributed in a round-robin manner between processing cores, where a subsequent task is distributed to a next processing core from the processing core that the previous task was distributed to.

Alternatively, processing tasks may be distributed to processing cores by distributing a next task to a processing core when the processing core completes a previous task, and/or by selecting a least loaded processing core when distributing a next task.

In an embodiment, when (both) tasks of the first type and other tasks not of the first type are to be distributed to the first and second sets of processing cores, tasks of the first type are distributed in a round-robin manner between processing cores of the first set of processing cores. The other tasks may be distributed in any suitable and desired way. In an embodiment, the other tasks are distributed in a round-robin manner amongst the remaining (active) processing cores.

In an embodiment, when (both) tasks of the first type and tasks of the second type are to be distributed to the first and second sets of processing cores, tasks of the first type are distributed in a round-robin manner between processing cores of the first set of processing cores and tasks of the second type are distributed in a round-robin manner between processing cores of the second set of processing cores.

It would be possible to distribute tasks (only) when one of the processing cores is available to process a task, for example (only) once a processing core has completed the processing of a previous task, and in an embodiment that is what is done.

However, in an embodiment tasks are distributed to processing cores in advance of the processing cores becoming available to process a (new) task.

In such embodiments, tasks to be processed are in an embodiment queued for a (and in an embodiment each) available processing core. Accordingly, in embodiments, a (and each) processing core has an associated queue of tasks to be processed, in an embodiment a first-in-first out (FIFO) queue. For example, and in embodiments, a (and each) processing core is associated with a respective buffer for storing tasks to be processed by the respective processing core. The buffers may be any suitable and desired buffer, such as a first-in-first-out (FIFO) buffer.

When one or more processing jobs are received, it would be possible to distribute all of the processing tasks for the processing job(s) to the processing cores, for example placing all of the processing tasks in one of the queues associated with the processing cores, and in embodiment that is what is done.

In some embodiments, a (and each) processing core may (only) queue up to a particular (maximum) number of tasks. For example, a (and each) processing core may queue up to 2, 4, 8 or any other suitable number of tasks. In some embodiments, the maximum number of tasks that can be queued is a fixed, in an embodiment pre-determined, number of tasks.

However, in an embodiment, the maximum number of tasks that can be queued by a (and each) processing core is controlled dynamically (i.e. can be set and varied in use).

In an embodiment, the maximum number of tasks that can be queued on a (and each) processing core is varied based on the number of tasks in a processing job that is being performed and/or on the number of (active) processing cores.

In some embodiments, the maximum number of tasks is the lower of a fixed, an embodiment pre-determined, threshold value and the total number of tasks in the processing job divided by the number of processing cores (or by the number of active processing cores).

The threshold value may be any suitable and desired value, such as 2, 4, 8 or any other suitable value. In some embodiments, the threshold is determined based on the number of tasks required to fully utilize all of the resources in a processing core, for example and in embodiments the threshold is the number of warp slots in the shader core.

In some embodiments, the maximum number of tasks is a total number of tasks that can be queued, independent of the type of task.

However, in other embodiments, a (and each) processing core has a maximum number of tasks of the first type that can be queued, and may also have a (separate) maximum number of tasks of the second type that can be queued.

In some embodiments, a (and each) processing core has a maximum number of tasks for only one type of task, for example a maximum number of tasks of the first type that can be queued, whilst having no maximum number of tasks for another type of task.

For example, and in an embodiment, when the tasks of the first type are compute tasks and the second tasks are non-compute tasks, a (and each) processing core may have a maximum number of compute tasks that can be queued, but no limit to the number of non-compute tasks that can be queued.

In some embodiments, processing cores in the first set of processing cores have a maximum number of tasks (in embodiments a maximum number of tasks of the first type) that can be queued, whilst processing cores in the second set of processing cores do not have a maximum number of tasks that can be queued.

In some embodiments, whether a processing core has a maximum number of tasks that can be queued depends on the type of tasks being distributed. For example, and in an embodiment, when tasks of the first type and tasks of another type are being distributed to processing cores, processing cores of the first set of processing core may have a maximum number of tasks of the first type that can be queued. However, when only tasks of the first type are being distributed, processing cores of the first set of processing cores may have no maximum number of tasks that can be queued.

The Applicants have identified that limiting the number of tasks that can be assigned (in advance) to (queued for) a particular processing core may be particularly beneficial when a (e.g. larger) processing job is finishing. Particularly, by limiting the number of tasks that can be queued on a (each) processing core, serialization issues are reduced.

For example, when tasks of the first type are to be distributed along with a small number of other tasks (for example when tasks for a compute job are to be distributed along with a number of remaining non-compute tasks to be distributed and processed at the end of a non-compute job), the tasks of the first type may be placed in the queues for (only) processing cores of the first set of processing cores. If all of the tasks of the first type are queued on (only) the first set of processing cores, there may be a relatively large number of processing tasks queued on the processing cores of the first set of processing cores. However, the second set of processing cores may then finish processing the other tasks, such that the tasks of the first type could (also) have been processed using these cores.

The Applicants have identified that by limiting the number of tasks that can be queued on a (each) processing core, such serialization issues are reduced.

As such, in an embodiment, distributing one or more tasks for the processing job or jobs to processing cores of the plurality of processing cores for processing comprises queueing one or more tasks for a (and each) respective processing core.

In embodiments, queueing one or more tasks for a respective processing core comprises queueing up to a particular maximum number of tasks for the processing core.

When the maximum number of tasks for a processing core is reached, no more tasks (or in some embodiments, no more tasks of a particular type) may be distributed to that processing core.

For example, when tasks of the first type and tasks of the second type are to be distributed to processing cores, and when there are sufficient tasks of the first type to fill the queues for each the first set of processing cores, tasks of the first type will be distributed to the first set of processing cores until the respective queues associated with the first set of processing cores are full (i.e. contain the particular maximum number of tasks).

When there (also) are a large number of tasks of the second type remaining, the tasks of the second type may be distributed to the second set of processing cores until the respective queues associated with the second set of processing cores are filled.

In this case, remaining tasks will be distributed respectively to queues of the first and second sets of processing cores once tasks from the queues have been processed (such that the queues are no longer full).

However, once all of the tasks of the first type or all of the tasks of the second type to be distributed have been distributed, any remaining tasks of the other of the tasks of the first type or tasks of the second type may be, and in an embodiment are, distributed to both the first and the second set of processing cores (e.g. all of the active processing cores).

In this way, serialization of the remaining tasks on either the first or second set of processing cores may be reduced.

When distributing remaining tasks of the other of the tasks of the first type and tasks of the second type to the first and second sets of processing cores, it would be possible to simply distribute the remaining tasks in a round-robin manner to all of the processing cores of the first and the second sets of processing cores, and in an embodiment that is what is done.

However, in an embodiment, remaining tasks are allocated in a round-robin manner (only) amongst the processing cores with the fewest outstanding tasks (i.e. amongst those processing cores with the shortest queues).

In this manner, serialization may be further reduced. In particular, the Applicants have identified that, when switching from distributing tasks of a first type to a first set of processing cores and tasks of a second type to a second set of processing cores to distributing tasks of the first or second type to both the first set of processing cores and the second set of processing cores, there may be different numbers of tasks (already) queued on the first set of processing cores and second set of processing cores.

By distributing remaining tasks in a round-robin manner amongst the processing cores with the fewest outstanding tasks, the differences in queue length between the first and second sets of processing cores can be reduced or eliminated, thereby further increasing utilisation of the processing cores.

Whilst embodiments relate to the distribution of tasks of a first type and tasks of a second type to first and second sets of processing cores, it will be appreciated that there may be further types of tasks that are distributed to the first and second sets of processing cores. These further types of task may be any suitable and desired further type of task, and may be distributed to the first and second sets of processing cores in any suitable and desired way.

For example, such further types of tasks may be treated as having a lower or higher priority for processing than the first and/or second types of tasks.

For example, there may be a “global” priority for all of the processing cores for the tasks of the further type, where all of the processing cores are configured (together) to have either a higher or a lower priority for tasks of the further type than for tasks of the first type or tasks of the second type.

Similarly, the graphics processor may comprise further processing cores that are not in the first or second sets of processing cores, which further processing cores may be configured to have a different priority for the processing of tasks of the first, second (and any further) type as desired.

Other arrangements are, of course, possible as desired.

The graphics processor (and system) of the technology described herein can be any suitable and desired graphics processor (and system).

The output to be generated may comprise any suitable output that can be generated by a graphics processor, such as a frame for display, or render-to-texture output, etc. The output data values from the processing are in an embodiment exported to external, e.g. main, memory, for storage and use, such as to a frame buffer for a display. In an embodiment, the output is an output frame in a sequence of plural output frames (e.g. to be displayed) that the graphics processor (and system) generates.

The graphics processor (graphics processing unit (GPU)) should, and in an embodiment does, execute a graphics processing pipeline. The graphics processor can execute any suitable and desired graphics processing pipeline, and may and in an embodiment does, include any suitable and desired processing circuits, processing logic, components and elements for that purpose.

The graphics processing pipeline that the graphics processor executes can include any suitable and desired processing stages for generating a (the) graphics output (e.g. frame). Thus, the graphics processing pipeline can include, and in an embodiment does include any one or one or more, and in an embodiment all, of the processing stages that graphics processing pipelines normally include. Thus, for example, the graphics processing pipeline in an embodiment includes a vertex shading stage, primitive setup stage, a rasteriser and a renderer. In an embodiment the renderer is in the form of or includes a fragment shader. The renderer may in general support any suitable and desired rendering scheme, including rasterisation-based rendering, ray-tracing, or “hybrid” ray-tracing.

The graphics processing pipeline may also contain any other suitable and desired processing stages that a graphics processing pipeline may contain such as a depth (or depth and stencil) tester, a blender, etc. When the pipeline is a tile-based pipeline, the pipeline in an embodiment also comprises a tiling stage, and/or a tile buffer for storing tile sample values and/or a write out unit that operates to write the data in the tile buffer (e.g. once the data in the tile buffer is complete) out to external (main) memory (e.g. to a frame buffer).

A (and each) processing stage (circuit) of the graphics processing pipeline (processor) can be implemented as desired, e.g. as a fixed function hardware unit (circuit) or as a programmable processing circuit (that is programmed to perform the desired operation). In an embodiment, at least the vertex shading stage and/or the fragment shading stage are implemented by a programmable execution unit (shader core) of the graphics processor executing an appropriate shader (program) that is in an embodiment supplied by the application that requires the graphics processing.

The graphics processing system can include any (other) suitable and desired components. In an embodiment, the graphics processing system includes a host processor which is operable to issue graphics processing commands (and data) to the graphics processor (GPU).

Thus, the graphics processing pipeline is in an embodiment executed (by the graphics processor (GPU)) in response to commands issued by a host processor of the graphics processing system. The host processor can be any suitable and desired processor, such as and in an embodiment a central processing unit (CPU), of the graphics processing system.

In an embodiment, the host processor of the graphics processing system generates the graphics processing commands (and data) for the graphics processor (GPU) in response to instructions from an application executing on the host processor. This is in an embodiment done by a driver for the graphics processor (GPU) that is executing on the host processor.

The graphics processing system should, and in an embodiment does, (further) comprise a memory. The memory can be any suitable and desired storage. The memory may be an on-chip memory (i.e. on the same chip as the host processor and/or the graphics processor) or it may be an external (main) memory (i.e. not on the same chip as the host processor and/or the graphics processor). Where the memory is an external memory, it may be connected to the host processor and/or to the graphics processor by a suitable interconnect.

In an embodiment, the various functions of the technology described herein are carried out on a single graphics processing platform that generates and outputs data (such as rendered fragment data that is, e.g., written to the frame buffer), for example for a display device.

The technology described herein can be implemented in any suitable system, such as a suitably configured micro-processor based system. In an embodiment, the technology described herein is implemented in a computer and/or micro-processor based system.

The technology described herein is in an embodiment implemented in a portable device, such as, and in an embodiment, a mobile phone or tablet.

The various functions of the technology described herein can be carried out in any desired and suitable manner. For example, the functions of the technology described herein can be implemented in hardware or software, as desired. Thus, for example, the various functional elements, stages, and “means” of the technology described herein may comprise a suitable processor or processors, controller or controllers, functional units, circuits, circuitry, processing logic, microprocessor arrangements, etc., that are operable to perform the various functions, etc., such as appropriately dedicated hardware elements (processing circuits/circuitry) and/or programmable hardware elements (processing circuits/circuitry) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuits/circuitry, etc., if desired.

It will also be appreciated by those skilled in the art that all of the described embodiments of the technology described herein can include, as appropriate, any one or more or all of the features described herein.

The methods in accordance with the technology described herein may be implemented at least partially using software e.g. computer programs. It will thus be seen that when viewed from further embodiments the technology described herein provides computer software specifically adapted to carry out the methods herein described when installed on a data processor, a computer program element comprising computer software code portions for performing the methods herein described when the program element is run on a data processor, and a computer program comprising code adapted to perform all the steps of a method or of the methods herein described when the program is run on a data processing system. The data processing system may be a microprocessor, a programmable FPGA (Field Programmable Gate Array), etc.

The technology described herein also extends to a computer software carrier comprising such software which when used to operate a graphics processor, renderer or other system comprising a data processor causes in conjunction with said data processor said processor, renderer or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein provides computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

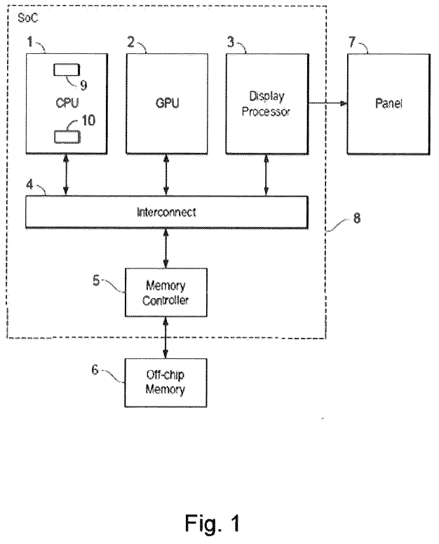

FIG. 1 shows an exemplary system on chip (SoC) graphics processing system 8 that comprises a host processor comprising a central processing unit (CPU) 1, a graphics processor (GPU) 2, a display processor 3, and a memory controller 5. The exemplary data processing system may also comprise a video engine (not shown in FIG. 1). As shown in FIG. 1, these units communicate via an interconnect 4 and have access to off-chip memory 6. In this system, the graphics processor 2 will render frames (images) to be displayed, and the display processor 3 will then provide the frames to a display panel 7 for display.

In use of this system, an application 9 such as a game, executing on one or more host processors (CPUs) 1 will, for example, require the display of frames on the display panel 7. To do this, the application will submit appropriate commands and data to a driver 10 for the graphics processor 2, e.g. that is executing on a CPU 1. The driver 10 will then generate appropriate commands and data to cause the graphics processor 2 to render appropriate frames for display and to store those frames in appropriate frame buffers, e.g. in the main memory 6. The display processor 3 will then read those frames into a buffer for the display from where they are then read out and displayed on the display panel 7 of the display.

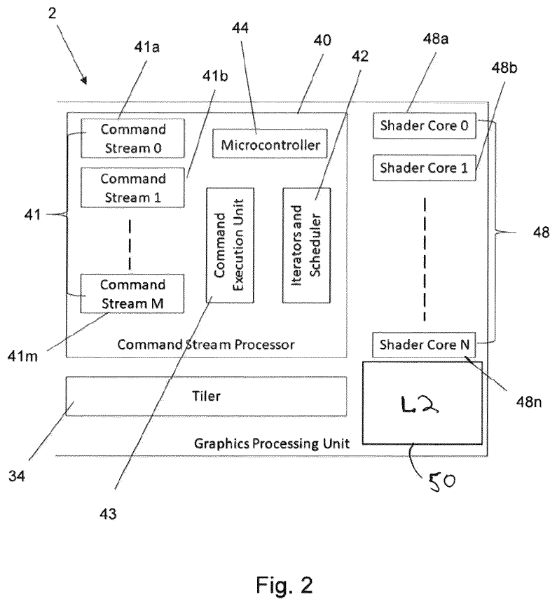

FIG. 2 shows schematically a graphics processor (GPU) 2 that may be operated in the manner of the technology described herein.

The graphics processor 2 comprises a command stream processor 40, which receives a plurality of command streams 41 (e.g. from memory), for example generated by the host CPU 1. Processing jobs are included in the command streams 41, for processing by the graphics processor 2.

Different command streams (41a-41m) may be for different (types) of processing job. The different command streams may be for any suitable and desired processing job that the graphics processor can process.

In the present embodiments, at least one of the command streams 41 is for compute jobs, which are for computing arbitrary information. The compute jobs can be used for processing graphics-related data, or for tasks not directly related to performing graphics processing.

In the present embodiments, another one of the command streams is for geometry jobs. The geometry jobs may be for performing vertex processing, or for processing other vertex attributes (varyings), such as colours, transparency, etc.

The graphics processor includes a plurality of shader cores (processing cores) 48, which are used for processing the processing jobs, and on-chip storage in the form of an L2 cache 50.

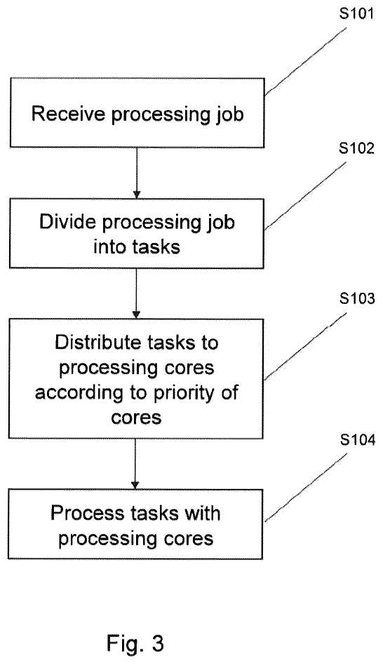

FIG. 3 is a flowchart describing the processing of processing jobs using the graphics processor 2 of FIG. 2.

To process a processing job using the graphics processor, the processing job is first received by the graphics processor (S101). In the present embodiments, the processing job is received from one of the command streams 41.

The command execution unit 43 receives the processing job from the command stream, and sends the processing job to an iterator 42 to be divided into one or more tasks (S102).

The one or more tasks are then distributed to the shader cores (processing cores) 48 for processing (S103). In the present embodiments, different ones of the shader cores (48a-48n) have different priorities for the processing of one or more different types of tasks. When distributing tasks to the shader cores 48, the tasks of different types are distributed in accordance with the priority of the core for tasks of that type.

The tasks are then processed by respective ones of the shader cores 48 (S104).

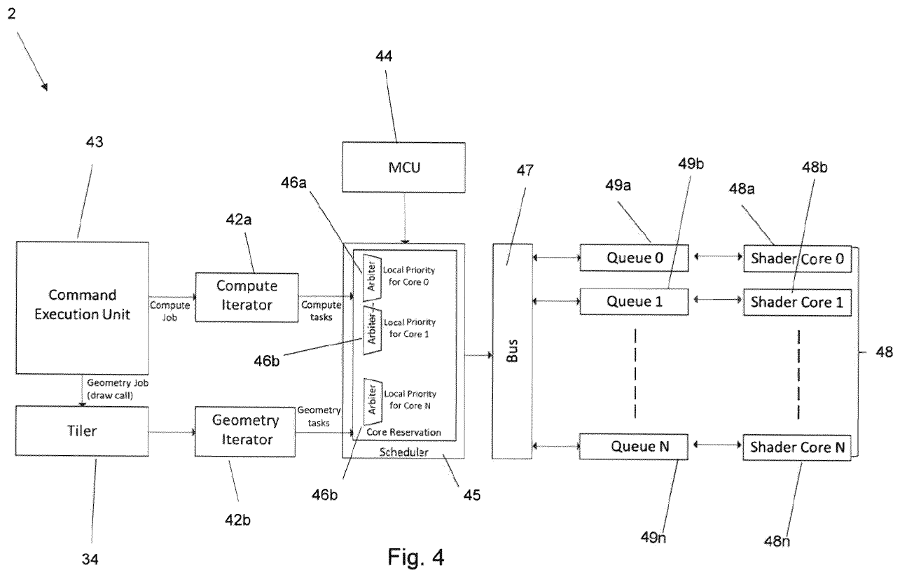

FIG. 4 shows schematically a graphics processor distributing processing tasks for two different workloads in an embodiment.

In the graphics processor of FIG. 4, there are two different iterators 42. The first iterator is a compute iterator 42a, which receives compute jobs from the command execution unit 43 and divides the compute jobs into one or more compute tasks (which in this embodiment are tasks of a first type) to be distributed to the shader cores 48.

The second iterator is a geometry iterator, which receives geometry jobs, for example for a particular draw call, from the command execution unit 43 and/or a tiler 34. The geometry iterator 42b divides these geometry jobs into one or more geometry tasks (which in this embodiment are tasks of a second type) to be distributed to the shader cores 48.

In the graphics processor of FIG. 4, the distribution of tasks to the shader cores 48 via the bus 47 is performed by a scheduler 45. The scheduler determines which one of the shader cores 48 a (and each) processing task should be processed by and distributes the processing task via the bus 47 to that shader core 48.

It will be appreciated that whilst the scheduler 45 is shown in FIG. 4 as a separate unit of the graphics processor for ease of explanation, the scheduler may instead be part of the iterators 42, as shown in FIG. 2.

The scheduler 45 includes respective arbiters (46a-46n) for each shader core (48a-48n). The arbiters 46 may be any suitable and desired arbiter such as a control bit. The arbiters 46 indicate a priority for a respective shader core 48 for the processing of compute tasks or for the processing of geometry tasks.

When both geometry tasks and compute tasks are to be distributed by the scheduler 45, geometry tasks are distributed to the shader cores 48 that are indicated by the arbiters 46 to have a higher priority for the geometry tasks, and compute tasks are distributed to the shader cores 48 that are indicated by the arbiters 46 to have a higher priority for the compute tasks.

In this way, the compute workload may be progressed simultaneously to the geometry workload, on different subsets of the shader cores 48, thereby providing improved utilisation of shader cores and throughput of tasks.

It will be appreciated that whilst the scheduler 45 may prioritise the processing of compute or geometry tasks on different sets of the shader cores (in accordance with the arbiters 46), when only compute tasks, or only geometry tasks, are to be distributed then these may be distributed to all of the shader cores 48.

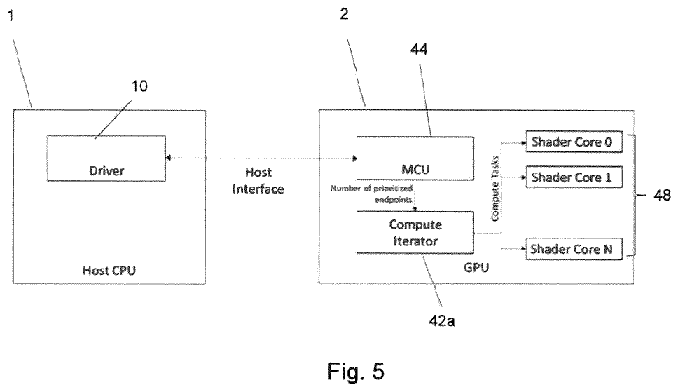

FIG. 5 shows schematically how the priority of shader cores 48 for processing compute tasks may be set.

A driver 10 running on a host CPU 1 programs or sets (configures) a suitable controller or manager for the graphics processor, which in the illustrated embodiments is a microcontroller (MCU) 44 of the graphics processor. In the present embodiment, the driver sets both a threshold number of (active) shader cores that do not prioritise the compute tasks, and also a ratio of the number of cores that will process the compute tasks.

The threshold sets a minimum number of (active) shader cores that will not prioritise compute tasks (for example that will prioritise geometry work). At least the threshold number of cores are set to not prioritise compute tasks (e.g. to prioritise the geometry work). When the number of active shader cores 48 is greater than the threshold, a number of shader cores above the threshold are set to prioritise compute tasks in accordance with the ratio.

In this embodiment, the number of shader cores prioritizing compute tasks may be determined as: ceiling [the number of active cores−threshold)/ratio]. However, it will be appreciated that the number of shader cores prioritizing compute tasks may be determined other ways as desired, for example by setting only one of a ratio or a threshold number of (active) processing cores.

Once the MCU 44 has calculated a number of processing cores that will prioritise the compute tasks, the MCU then sets the priorities of those cores, for example by writing to the respective arbiters 46. To write to the arbiters 46, the MCU 44 may propagate a mask to the arbiters 46, the mask indicating a priority for each of the respective arbiters 46.

The shader cores 48 are associated with a queue 49. In this embodiment, individual shader cores (48a-48n) are associated with a respective queue (49a-49n). In this embodiment, the respective queues are first-in-first-out (FIFO) buffers. When tasks are distributed by the scheduler to a respective shader core 48, they are placed in the respective queue 48 for that shader core 49. Tasks from the queue 49 are then processed by the respective shader core 48 in a first-in-first-out manner.

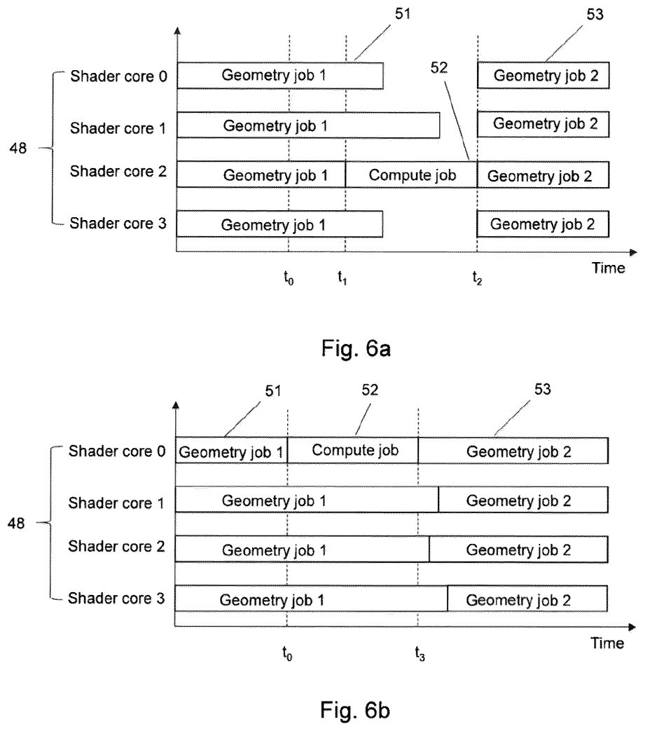

FIGS. 6a and 6b show schematically the processing of tasks for a first geometry job 51, a second geometry job 53 and a compute job 52 over time on a graphics processor including four shader cores 48. The compute job 52 is latency critical for the second geometry job 53, such that processing of the second geometry job 53 cannot be started until the compute job 52 is completed.

FIG. 6a shows an example of the processing of tasks over time without the prioritising different types of tasks on different shader cores 48.

In this example, there is a global prioritisation for geometry tasks, such that tasks for geometry jobs are distributed to the processing cores in preference to any compute tasks. As such, the tasks for the first geometry job 51 are distributed to all of the shader cores 48 for processing.

When the compute job 52 is received at time to, this is not processed until one of the shader cores (in this case shader core 2) has finished processing the first geometry job 51 at time t1. However, the second geometry job 53 cannot be started until the compute job 52 has been completed at time t2. Accordingly, the shader cores other than shader core 2 are left unused for a period before time t2.

In contrast, FIG. 6b shows schematically the processing of tasks for the same three processing jobs when prioritising compute tasks on one or more shader cores 48. In this case, shader core 0 is set to prioritise compute tasks.

To begin with, each of the shader cores 48 processes tasks for the first geometry job 51. When the compute job 52 is received at time to, the compute job 52 is prioritised on shader core 0 such that processing of tasks for the compute job 52 is (immediately) started. Any tasks for the first geometry job that would have been processed by shader core 0 are instead distributed to, and processed by, the other shader cores.

As such, the compute job 52 is finished at an earlier time t3, and therefore processing of the second geometry job 53 can be started sooner. In this way, throughput of tasks can be increased, and latency in the system can be reduced.

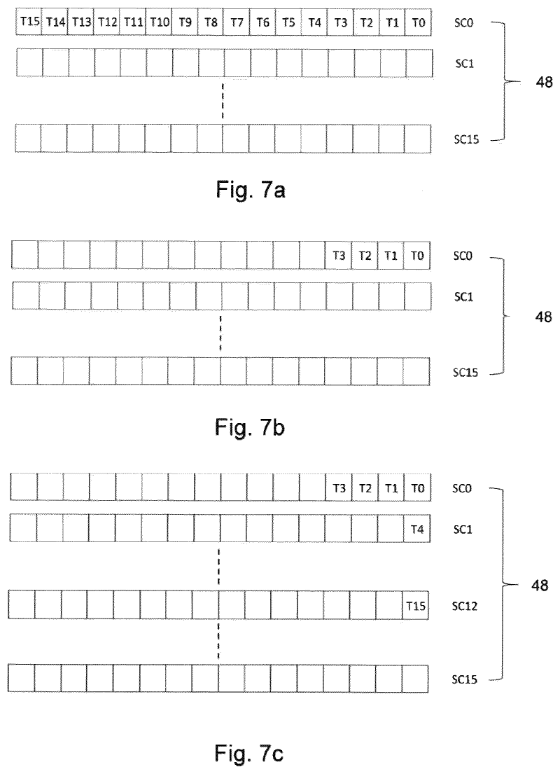

FIGS. 7a to 7c show schematically the distribution of tasks of a first type (for example compute tasks) to a plurality of shader cores in accordance with embodiments of the technology described herein.

In particular, FIGS. 7a to 7c show the distribution of processing tasks for a (latency-critical) compute job comprising sixteen compute tasks (T0-T15) to the queues 49 of a graphics processor comprising sixteen shader cores 48, where one of the shader cores (SC0) is configured to prioritise processing of the compute tasks. In FIGS. 7a and 7b, each of the shader cores (SC0-SC15) is currently processing non-compute tasks for a previous processing job.

In FIG. 7a, no limit is placed on the number of processing tasks that can be queued by the shader cores. As such, as shader cores SC1 to SC15 are (still) processing the non-compute tasks, the compute tasks for the (new) processing job are all distributed to (and queued for) the shader core SC0 that is prioritising the compute tasks.

As can be seen in FIG. 7a, this leads to a serialisation issue where all 16 compute tasks are queued for the shader core SC0 that is prioritising the compute tasks. However, once the remaining shader cores SC1-SC15 finish processing their (final) non-compute task, no more tasks are issued until the latency-critical compute job has completed (i.e. after shader core SC0 has processed all of the compute tasks T0-T15). This leads to inefficient use of the processing resource.

In contrast, in FIG. 7b, the number of compute tasks that can be queued for shader core SC0 is limited to 4. As such, when the compute job comprising 16 compute tasks (T0-T15) is received, only four tasks (T0-T3) will be distributed to the shader core SC0 that is prioritising compute tasks. Whilst the remaining shader cores (SC1-SC15) are processing non-compute tasks for the non-compute job, no processing tasks are distributed to them.

However, once the remaining shader cores (SC1-SC15) finish processing the non-compute tasks, as shown in FIG. 7c, the remaining compute tasks for the compute job (T4-T15) will be distributed to these remaining shader cores, thereby reducing serialisation.

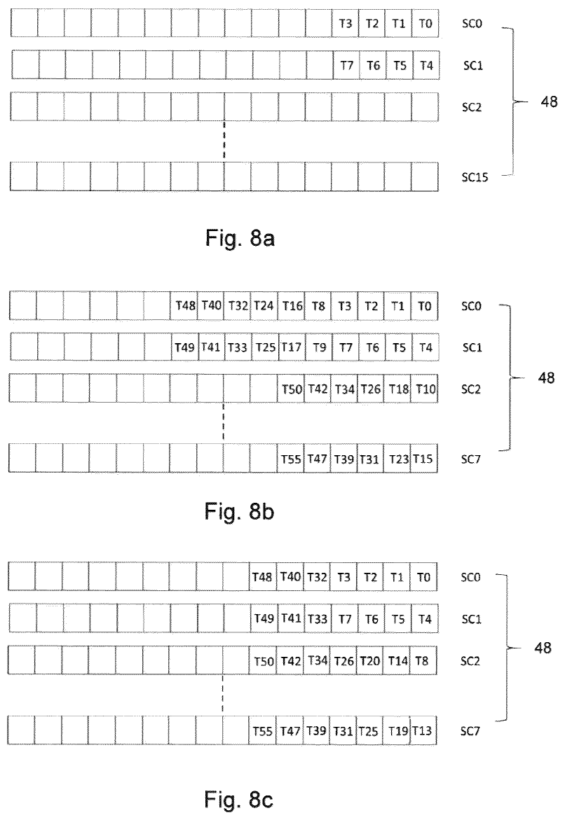

FIGS. 8a to 8c show schematically the distribution of tasks for a compute job comprising 56 tasks to the shader cores of a graphics processor comprising 8 processing cores. Two of the shader cores (SC0 and SC1) are arranged to prioritise the processing of compute tasks. Initially, the remaining processing cores are processing non-compute tasks. A maximum of four compute tasks may be queued for each shader core.

As shown in FIG. 8a, whilst the shader cores are processing non-compute tasks, the compute tasks are distributed to (just) the shader cores prioritising compute tasks (SC0 and SC1), until the maximum number of compute tasks has been queued for each of shader cores SC0 and SC1.

As shown in FIG. 8b, once the non-compute tasks have been processed, the remaining compute tasks (T8-T55) are distributed in a round-robin manner amongst the shader cores. As such, six additional tasks are distributed to each shader core. This leads to a serialisation issue, where more of the compute tasks are distributed to the shader cores that prioritised compute tasks (SC0 and SC1) than are distributed to the remaining shader cores (SC2 to SC7).

FIG. 8c shows an alternative way of distributing the remaining compute tasks (T8-T55) once the non-compute tasks have been processed. In this case, tasks are distributed in a round-robin manner to the shader cores having the fewest queued tasks.

As such, initially, remaining compute tasks (T8-T31) for the compute job are distributed (only) to the shader cores with the shortest queues (SC2-SC7), until all of the shader cores (SC0-SC7) have the same number of tasks distributed thereto. After this, any remaining tasks for the compute job (T32-T55) are distributed in a round-robin manner amongst all of the shader cores (SC0-SC7). In this manner serialisation is further reduced.

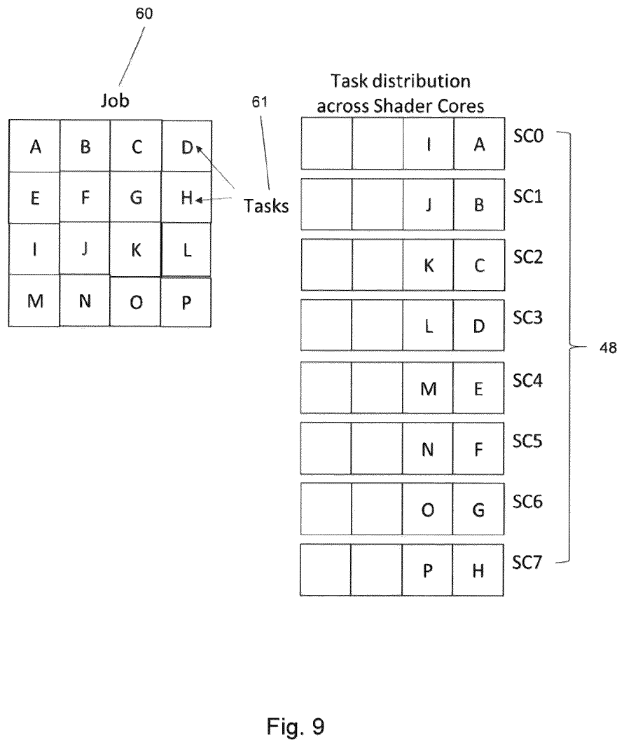

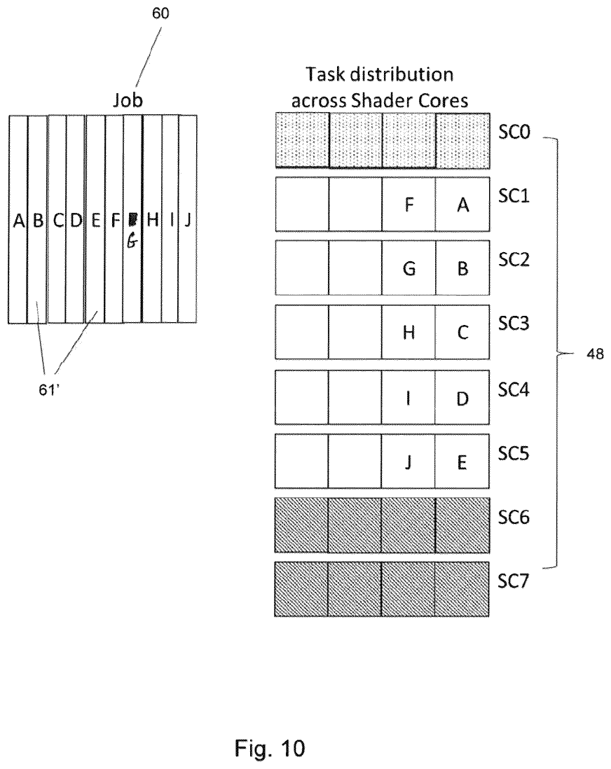

FIGS. 9 and 10 show schematically the distribution of a processing job 60 into tasks 61, 61′ for processing by shader cores 48 of a graphics processor. In each of FIGS. 9 and 10, the graphics processor comprises 8 shader cores (SC0-SC7).

In FIG. 9, all of the shader cores are active and available to receive tasks. The processing job 60 is divided into a number of tasks 61, that is a multiple of the number of shader cores 48. In this case, the processing job 60 is divided into 16 tasks 61, such that two tasks can be (and are) distributed to each of the shader cores 48. In this way, all of the shader cores receive the same number of tasks for processing, thereby providing more efficient utilisation of the processing resources.

In FIG. 10, shader cores SC6 and SC7 are inactive. Shader core SC0 is set to prioritise tasks of a different type to those for the processing job 61. Shader cores SC1-SC5 are set to prioritise tasks of the type produced by the processing job 61. As such, when the shader core SC0 is processing tasks of the different type, only shader cores SC1-SC5 are available to process tasks 61′ for the processing job 60.

As such, the processing job 60 is divided into (only) 10 tasks 61′, which are larger than the tasks 61 of FIG. 9. In this way, each of the shader cores that are processing the tasks 61′ receive two processing tasks. In this way, efficient utilisation of the shader cores is provided, even when the number of shader cores used for processing the tasks is not fixed.

It can be seen from the above that the technology described herein, in its embodiments at least, can provide for more efficient distribution of tasks for processing in graphics processors comprising plural processing (shader) cores. This is achieved, in the embodiments of the technology described herein at least, by configuring a first set of one or more of the processing cores of the graphics processor to have a higher priority for the processing of tasks of a first type compared to a second set of one or more others of the processing cores, and distributing tasks to the first and second sets of one or more processing cores for processing in accordance with the priorities of those sets of one or more processing cores for the processing of tasks of the first type.

Whilst the foregoing detailed description has been presented for the purposes of illustration and description, it is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A method of operating a graphics processor, the graphics processor comprising a plurality of processing cores, the processing cores operable to execute processing tasks for processing jobs, the method comprising:
receiving one or more processing jobs for processing by the graphics processor;
distributing one or more tasks for the processing job or jobs to processing cores of the plurality of processing cores for processing; and
processing the tasks with the respective processing cores;
wherein a first set of one or more of the processing cores of the graphics processor is configured to have a higher priority for the processing of tasks of a first type compared to a second set of one or more others of the processing cores; the method comprising:
distributing the tasks to the first and second sets of one or more processing cores for processing in accordance with the priorities of those sets of one or more processing cores for the processing of tasks of the first type.

2. The method of claim 1, wherein distributing one or more tasks for the processing job or jobs to processing cores of the plurality of processing cores for processing comprises queueing one or more tasks for respective processing cores.

3. The method of claim 2, wherein queueing one or more tasks for a respective processing core comprises queueing up to a particular maximum number of tasks for the processing core.

4. The method of claim 1, wherein when distributing tasks to the first and second set of processing cores, the tasks to be distributed comprising only one or more tasks of the first type, then tasks of the first type are distributed to both the first and the second set of processing cores.

5. The method of claim 1, wherein when distributing tasks to the first and second set of processing cores, the tasks comprising one or more tasks of the first type and one or more processing tasks of another type, the processing tasks of the first type are distributed to the first set of processing cores, whilst the other processing tasks are distributed to the second set of processing cores.

6. The method of claim 1, wherein distributing one or more tasks for the processing job or jobs to processing cores of the plurality of processing cores for processing comprises queueing one or more tasks for a respective processing core, the method further comprising, when distributing tasks to the first and second set of processing cores, the tasks comprising one or more tasks of the first type and one or more processing tasks of another type:
when all of the tasks of the first type have been distributed, distributing the processing tasks of another type to the first and second sets of processing cores by prioritising distributing the tasks of another type to processing cores that have the smallest number of queued tasks.

7. The method of claim 1, wherein the tasks of the first type are compute tasks.

8. The method of claim 1, wherein the second set of processing cores is configured to have a higher priority for the processing of tasks of a second type compared to the first set of one or more of the processing cores, the method comprising distributing tasks to the first and second sets of one or more processing cores for processing in accordance with the priorities of those sets of one or more processing cores for the processing of tasks of tasks of the second type.

9. The method of claim 8, wherein the tasks of a second type are non-compute tasks.

10. A method of operating a graphics processor, the graphics processor comprising a plurality of processing cores, the processing cores operable to execute processing tasks for processing jobs, the method comprising:
receiving one or more processing jobs for processing by the graphics processor;
distributing one or more tasks for the processing job or jobs to processing cores of the plurality of processing cores for processing; and
processing the tasks with the respective processing cores;
wherein a first set of one or more of the processing cores of the graphics processor is configured to have a higher priority for the processing of tasks of a first type compared to tasks of a second type, and a second set of one or more others of the processing cores is configured to have a higher priority for the processing of tasks of the second type compared to tasks of the first type;
the method comprising:
distributing tasks to the first and second sets of one or more processing cores for processing in accordance with the priorities of those sets of one or more processing cores for the processing of tasks of the first type and for the processing of tasks of the second type.

11. A graphics processor comprising:
a plurality of processing cores, the processing cores operable to execute processing tasks for processing jobs;
a task distribution circuit configured to distribute tasks for processing jobs to processing cores of the plurality of processing cores for processing; and
a processing circuit or circuits operable to configure a first set of one or more of the processing cores of the graphics processor to have a higher priority for the processing of tasks of a first type compared to a second set of one or more others of the processing cores;
wherein the task distribution circuit is configured to:
distribute tasks to the first and second sets of one or more processing cores for processing in accordance with the priorities of those sets of one or more processing cores for the processing of tasks of the first type.

12. The graphics processor of claim 11, wherein the task distribution circuit is configured to, when distributing one or more tasks for the processing job or jobs to processing cores of the plurality of processing cores for processing, distribute one or more tasks for a respective processing core to a queue associated with the processing core.

13. The graphics processor of claim 12, wherein the task distribution circuit is configured to, when distributing one or more tasks for a respective processing core to a queue associated with the processing core, queue up to a particular maximum number of tasks for the processing core.

14. The graphics processor of claim 11, wherein the task distribution circuit is configured to, when distributing tasks to the first and second set of processing cores, the tasks comprising only one or more tasks of the first type, distribute tasks of the first type to both the first and the second set of processing cores.

15. The graphics processor of claim 11, wherein the task distribution circuit is configured to, when distributing tasks to the first and second set of processing cores, the tasks comprising one or more tasks of the first type and one or more processing tasks of another type, distribute the processing tasks of the first type to the first set of processing cores, whilst the other processing tasks are distributed to the second set of processing cores.

16. The graphics processor of claim 11, wherein the task distribution circuit is configured to, when distributing one or more tasks for the processing job or jobs to processing cores of the plurality of processing cores for processing, distribute one or more tasks for a respective processing core to a queue associated with the processing core, wherein the task distribution circuit is further configured to, when distributing tasks to the first and second set of processing cores, the tasks comprising one or more tasks of the first type and one or more processing tasks of another type:
when all of the tasks of the first type have been distributed, distributing the processing tasks of another type to the first and second sets of processing cores by prioritising distributing the tasks of another type to processing cores that have the smallest number of queued tasks.

17. The graphics processor of claim 11, wherein the tasks of the first type are compute tasks.

18. The graphics processor of claim 11, wherein the second set of processing cores is configured to have a higher priority for the processing of tasks of a second type compared to the first set of one or more of the processing cores.

19. A non-transitory computer readable storage medium storing computer software code which when executing on at least one processor, performs a method of operating a graphics processor, the graphics processor comprising a plurality of processing cores, the processing cores operable to execute processing tasks for processing jobs, the method comprising:
receiving one or more processing jobs for processing by the graphics processor;
distributing one or more tasks for the processing job or jobs to processing cores of the plurality of processing cores for processing; and
processing the tasks with the respective processing cores;
wherein a first set of one or more of the processing cores of the graphics processor is configured to have a higher priority for the processing of tasks of a first type compared to a second set of one or more others of the processing cores; the method comprising:
distributing the tasks to the first and second sets of one or more processing cores for processing in accordance with the priorities of those sets of one or more processing cores for the processing of tasks of the first type.
